(19) United States
(12) Patent Application Publication
(10) Pub. No.: US 2012/0301694 A1
(43) Pub. Date: Nov. 29, 2012

(54) NONWOVEN WITH IMPROVED FIRE BARRIER PERFORMANCE

(75) Inventors: Sang-Hoon Lim, Kennesaw, GA (US); Andrea Piana, Atlanta, GA (US)

(73) Assignee: Tintoria Piana U.S., Inc., Cartersville, GA (US)

(21) Appl. No.: 13/179,911

(22) Filed: Jul. 11, 2011

Related U.S. Application Data
(60) Provisional application No. 61/490,641, filed on May 27, 2011.

(51) Int. Cl. B32B 27/12; B05D 3/02; B32B 5/00

(52) U.S. Cl. 428/219; 442/136; 427/372.2; 427/296

(57) ABSTRACT

Nonwoven containing inherent flame retardant cellulosic fibers has improved fire barrier performance, such as char elongation and char strength when the inherent flame retardant cellulosic fibers are treated with flame retardant chemicals. The flame retardant chemical treatment on the inherent flame retardant cellulosic fibers can be done either before or after the nonwoven formation.

### CROSS-REFERENCE TO RELATED APPLICATIONS

This application claims priority to U.S. Provisional Patent Application Ser. No. 61/490,641 filed May 27, 2011, the complete contents thereof being herein incorporated by reference.

### FIELD OF THE INVENTION

The present invention is related to a method to improve fire barrier performance of inherent flame retardant (FR) cellulosic fiber and its use as a nonwoven fire barrier.

### BACKGROUND

There has been an increasing demand for nonwoven fire barrier products for use in mattresses and upholstered furniture. For example, the new U.S. federal open-flame mattress standard (CPSC 16 CFR Part 1633) has created a new demand for flame retardant (FR) fibers in the mattress industry. A number of companies have been developing nonwoven fire barriers to meet the federal standard. Examples of the approaches now being used are described in the following recently issued patents.

U.S. Pat. No. 7,410,920 (Davis) describes a nonwoven fire barrier consisting of charring-modified viscose fibers (Visil®) with less than 5% of polymers made from halogenated monomers.

U.S. Pat. No. 7,259,117 (Mater et al.) discloses a nonwoven high-loft fire barrier for mattresses and upholstered furniture. The high-loft nonwoven is composed of melamine fiber alone or in conjunction with other fibers.

There are a number of synthetic FR fibers, i.e., the polymer backbone is modified to give flame retardancy. Synthetic FR fibers include aramids (Nomex® and Kevlar®), polyimide fibers (Ultem® polyetherimide and Extem® amorphous thermoplastic polyimide fibers), melamine fiber (Basofil®), halogen-containing fibers (Saran® fiber, modacrylics), polyphenylene sulfide fibers (Diofort®), oxidized polyacrylonitrile fibers (Pyron®), and cured phenol-aldehyde fibers (Kynol® novoloid fiber).

Despite their advantages, these synthetic FR fibers are expensive. From an economic perspective, most of them are not suitable for mattresses and upholstered furniture due to their high costs. For the mattress and upholstered furniture industries, the most cost-effective FR fibers are FR cellulosic fibers.

There are generally two types of FR cellulosic fibers. The first one is FR-treated cellulosic fiber. This is produced by applying FR chemicals on cellulosic fiber. Examples of cellulosic fiber include cotton, kapok, flax, ramie, kenaf, abaca, coir, hemp, jute, sisal, pineapple fiber, rayon, lyocell, bamboo fiber, Tencel®, and Modal®. FR-treated cellulosic fibers are commercially available from Tintoria Piana US, Inc. (Cartersville, Ga., USA).

The second type of FR cellulosic fiber is inherent FR cellulosic fiber. This is produced by adding FR compound to viscose dope and extruding the dope. Examples of inherent FR cellulosic fiber include, but are not limited to, phosphorous FR-containing rayon fibers (Lenzing FR®, Shangdong Helon's Anti-frayon®), and silica-containing rayon fibers (Visil®, Daiwabo's FR Corona®fibers, Sniace's FR fiber, and Shangdong Helon's Anti-fcell®).

### SUMMARY

An exemplary embodiment of the present invention is a nonwoven fire barrier containing FR-treated inherent FR cellulosic fiber. According to the invention, FR chemical treatment on inherent FR cellulosic fiber improves its fire barrier performance, in particular its physical properties such as char elongation and char strength, which are critical properties of fire barrier nonwoven.

### DETAILED DESCRIPTION

The present invention generally relates to nonwoven composition which contains FR-treated inherent FR cellulosic fiber. Inherent FR cellulosic fiber include, but are not limited to, phosphorous FR-containing rayon fibers (Lenzing FR®, Shangdong Helon's Anti-frayon®), and silica-containing rayon fibers (Visil®, Daiwabo's FR Corona®fibers, Sniace's FR rayon, and Shangdong Helon's Anti-fcell®).

FR chemical can be applied on inherent FR cellulosic fibers by several methods. These include, but are not limited to, mixing, spraying, and impregnation methods. For an exemplary mixing method, finely ground FR compound is mixed with the fiber in a mixing machine. A small amount of oil and surfactant are added to control dust and improve bonding of FR compound on the fiber. For an exemplary spraying method, a desired amount of FR chemical solution is sprayed on the fiber and the fiber is dried. For an exemplary impregnation method, the fiber is soaked in FR chemical solution, the excess amount of FR chemical solution is removed, and then the fiber is dried.

FR chemicals for FR treatment include, but are not limited to, phosphorus-containing FR chemicals, sulfur-containing FR chemicals, halogen-containing FR chemicals, antimony-containing FR chemicals, and boron-containing FR chemicals. Examples of FR chemicals include, but are not limited to, phosphoric acid and its derivatives, phosphonic acid and its derivatives, sulfuric acid and its derivatives, sulfamic acid and its derivatives, boric acid and its derivatives, borax, borates, ammonium phosphates, ammonium polyphosphates, ammonium sulfate, ammonium sulfamate, ammonium chloride, and ammonium bromide. In some embodiments of the invention, the FR chemicals used for the FR treatment may be different from the FR compound(s) added to the viscose dope used to make the inherent FR cellulosic fiber.

A “nonwoven” is a manufactured sheet, web, or batt of natural and/or man-made fibers or filaments that are bonded to each other by any of several means. Manufacturing of nonwoven products is well described in “Nonwoven Textile Fabrics” in Kirk-Othmer Encyclopedia of Chemical Technology, 3rd Ed., Vol. 16, July 1984, John Wiley & Sons, p. 72˜124 and in “Nonwoven Textiles”, Nov. 1988, Carolina Academic Press. Web bonding methods include mechanical bonding (e.g., needle punching, stitch, and hydro-entanglement), chemical bonding using binder chemicals (e.g., saturation, spraying, screen printing, and foam), and thermal bonding using binder fibers with low-melting points. Two common thermal bonding methods are air heating and calendaring. In air heating, hot air fuses low-melt binder fibers within and on the surface of the web to make a high-loft nonwoven. In the calendaring process, the web is passed and compressed between heated cylinders to produce low-loft nonwoven.

In the practice of this invention, the fire barrier material is a nonwoven containing FR-treated inherent FR cellulosic fibers. In addition, other fibers can be included in the nonwoven to achieve properties or characteristics of interest (e.g., color, texture, etc.). These may include natural fibers including, but not limited to, cotton, ramie, coir, hemp, abaca, sisal, kapok, jute, flax, kenaf, coconut fiber, pineapple fiber, wool, cashmere, and silk. In addition, these may include man-made fibers including, but not limited to, glass fibers, basalt fibers, polyesters, nylons, acrylics, acetates, polyolefins, melamin fibers, elastomeric fibers, polybenzimidazoles, aramid fibers, polyimide fibers, modacrylics, polyphenylene sulfide fibers, carbon fibers, Oxidized PAN fiber, Novoloid fibers, and manufactured cellulosic fibers (rayon, lyocell, bamboo fiber, tencel®, and modal®).

The nonwoven may be made using mechanical bonding, chemical bonding, or thermal bonding techniques.

As an exemplary method of producing a nonwoven containing FR-treated inherent FR cellulosic fiber according to the invention, a nonwoven containing inherent FR cellulosic fiber is treated with FR chemicals. Exemplary FR chemical application methods for the nonwoven include, but are not limited to, padding, spraying, kiss roll application, foam application, blade application, and vacuum extraction application. After a desired amount of FR chemical formulation is applied on the nonwoven by these methods, the nonwoven is dried. For example, in the padding method, the nonwoven is immersed in FR chemical solution, the amount of FR chemical on the nonwoven is controlled by adjusting pressure of the padder rolls, and then the nonwoven is dried in an oven.

The uses of the nonwoven fire barrier include, but are not limited to, mattresses, furniture, building insulations, automotive, appliances, and wall panels for cubicles.

### EXAMPLE 1

Nonwoven web samples with different fiber compositions were prepared using a lab carding machine. The carded samples were kept in a laboratory oven at 280° F. for 5 min for thermal bonding. For the samples, inherent FR cellulosic fibers (Shangdong Helon's Anti-fcell and Sniace's FR rayon), FR-treated inherent FR cellulosic fibers (Shangdong Helon's Anti-fcell and Sniace's FR rayon), FR-treated cotton fiber, and low-melt binder fiber (LM) were used. For a fair comparison, the total weight of each blend was controlled to be the same at 10 grams.

Each sample was completely burned to form a char using a burner horizontally located beneath the samples. Char strength and elongation were measured by a char tester. The tester is equipped with a loadcell connected to a vertically movable plate which presses char until its breakage. Char elongation was measured in the unit of inches and char strength was measured as peak force in the unit of pounds (lb).

TABLE 1
Effect of FR-treatment on inherent FR rayon fiber

| | Elongation | |
|---|---|---|
| Fiber blends (wt. %) | (inch) | Peak force (lb) |
| Sniace FR rayon:LM = 80:20 | 0.295 | 3.08 |
| FR-treated Sniace FR rayon:LM = 80:20 | 0.431 | 9.36 |
| Anti-fcell:FR-treated cotton:LM = 40:40:20 | 0.335 | 2.32 |
| FR-treated Anti-fcell:FR-treated cotton:LM = | 0.337 | 5.35 |
| 40:40:20 | | |

1. FR chemical for the FR treatment: ammonium sulfate
2. Sniace FR rayon is an inherent FR rayon fiber produced by Sniace.
3. Anti-fcell is an inherent FR rayon fiber produced by Shangdong Helon Co., Ltd.

Table 1 demonstrates the treatment of FR chemical on inherent FR cellulosic fiber increased its char elongation and char strength. This improved char performance will help to prevent possible char breakage under severe flame conditions which would otherwise cause further flame propagation.

### EXAMPLE 2

Thermal bonded high-loft nonwoven samples were prepared by using a nonwoven production line (i.e., the samples in Example 2 are made by commercial processes, whereas the samples in Example 1 were laboratory samples). FR Cellulosic fibers and low-melt binder fiber (LM) were blended at specific wt. % ratios. The blended fibers were carded to form a fiber web on a conveyor. The web is cross-lapped and passed through an oven to form a high-loft nonwoven. Various blend samples were prepared at different basis weight expressed as ounce per square foot (oz/ft²). The nonwoven samples were tested for char elongation and strength by the same method described in Example 1.

Table 2 shows FR chemical treatment on inherent FR rayon fiber increased both its char elongation and char strength significantly. From practical point of view, the results suggest that it is possible to use lower basis weight nonwoven product by using FR-treated inherent FR cellulosic fiber.

TABLE 2
Effect of FR-treatment on inherent FR rayon fiber

| | Weight of | | |
|---|---|---|---|
| | nonwoven | Elongation | Peak force |
| Fiber blends (wt. %) | (oz/ft²) | (inch) | (lb) |
| Anti-fcell:LM = 80:20 | 1.00 | 0.370 | 1.18 |
| FR-treated Anti-fcell:LM = 80:20 | 1.00 | 0.412 | 2.27 |
| Anti-fcell:LM = 80:20 | 0.80 | 0.342 | 0.74 |
| FR-treated Anti-fcell:LM = 80:20 | 0.80 | 0.399 | 1.51 |
| Anti-fcell:LM = 80:20 | 0.70 | 0.306 | 0.60 |
| FR-treated Anti-fcell:LM = 80:20 | 0.70 | 0.343 | 1.18 |
| Anti-fcell:FR-treated | 1.00 | 0.302 | 0.66 |
| cotton:LM = 40:40:20 | | | |
| FR-treated Anti-fcell:FR-treated | 1.01 | 0.338 | 1.65 |
| cotton:LM = 40:40:20 | | | |
| FR-treated Anti-fcell:FR-treated | 0.80 | 0.332 | 0.98 |
| cotton:LM = 40:40:20 | | | |

1. FR chemical for the FR treatment: ammonium sulfate
2. Anti-fcell is inherent FR rayon fiber produced by Shangdong Helon Co., Ltd.

What is claimed is:

1. Nonwoven containing FR-treated inherent FR cellulosic fiber.

2. The nonwoven of claim 1, further comprising one or more optional fibers which are different from said FR-treated inherent FR cellulosic fiber.

3. The nonwoven of claim 1, further comprising a low-melt binder fiber for thermal bonding of the nonwoven

4. The nonwoven of claim 1, wherein fibers are mechanically bonded together.

5. The nonwoven of claim 1, fibers are chemically bonded together.

6. The nonwoven of claim 1 wherein said nonwoven has a basis weight ranging from 0.1˜5.0 oz/ft² .

7. A method of making a nonwoven fire barrier with improved physical performance, comprising the steps of:
forming a nonwoven which includes at least one untreated inherent FR cellulosic fiber;
applying one or more fire retardant chemicals to the nonwoven;
and drying the nonwoven.

8. The method of claim 7 further comprising the step of passing the nonwoven through padder rolls prior to said drying step.

9. The method of claim 7 wherein said step of applying is performed by padding, spraying, kiss roll application, foam application, blade application, or vacuum extraction application.

10. The nonwoven of claim 7 wherein said nonwoven has a basis weight ranging from 0.1˜5.0 oz/ft² .
